(19) United States
(12) Patent Application Publication
(10) Pub. No.: US 2012/0263832 A1
(43) Pub. Date: Oct. 18, 2012

(54) Method and Apparatus for Processing Clams

(76) Inventor: Everett Davis, Sr., Byfield, MA (US)

(21) Appl. No.: 13/085,962

(22) Filed: Apr. 13, 2011

(51) Int. Cl. A23B 4/06; B65B 25/06; B65D 81/34; A23L 1/01

(52) U.S. Cl. 426/113; 426/393; 426/234; 426/392; 426/129

(57) ABSTRACT

Method of preserving clams. This method involves the steps of cleaning a clam, sorting the clam, freezing the clam while the clam is alive, packaging the clam, and cooking the clam. An apparatus for containing clams having a tray having an upper surface and a plurality of defined locations constructed and arranged to receive a clam, the clam deposited in one of the plurality of defined locations, and the tray disposed within a plastic freezer bag.

### FIELD OF THE INVENTION

The present disclosure relates generally to food processing and in particular relates to the freezing and cooking of clams.

### DESCRIPTION OF RELATED ART

Clams, particularly soft shell clams (mya arenaria) and jack knife clams (ensis directus) are a popular food in costal regions where they can be freshly harvested, such as in New England. These clams can be prepared in a variety of ways such as steamed, fried, or in clam chowder. However, the freshness of clams is vital to their quality. Clams typically die approximately ten days from harvesting and their quality decreases rapidly from the date of harvest. Therefore, conventional methods of processing, storing and shipping clams limit their quality and their ability to be transported beyond their native costal region.

Clams can also be inconvenient to prepare. Because of the importance of freshness, clams should be purchased as close to cooking time as possible. This can often involve the inconvenience of a trip out to a local market immediately before the clams are to be prepared, or the need to plan and coordinate the cooking of clams ahead of time.

A common downside to the eating experience of clams is excess sand grit in the clam. Various attempts at remedying this issue exist, including soaking clams in water with corn meal, and dipping the clams in broth before eating. However, these methods only partially succeed in reducing sand grit, and leave much to be desired.

Therefore, what is needed is a convenient way to package, store and prepare clams that reduces grit and does not decrease the quality of the clams.

### SUMMARY OF THE INVENTION

The subject matter of this application may involve, in some cases, interrelated products, alternative solutions to a particular problem, and/or a plurality of different uses of a single system or article.

In one aspect, a method of preserving clams is provided. This method comprises the steps of cleaning a clam, sorting the clam, freezing the clam while the clam is alive, packaging the clam, and cooking the clam.

In another aspect, a method of preserving and enhancing the eating experience of clams is provided. This method comprises the steps of cleaning a clam, sorting the clam, processing the clam to make the clam body easily removable from the clam shell, processing the clam to reduce the quantity of sand grit within the clam, processing the clam to preserve its freshness, packaging the clam, and cooking the clam.

In another aspect, an apparatus for containing frozen clams is provided. This apparatus comprises an inner tray having an upper surface and a plurality of defined locations each constructed and arranged to receive a clam, the clam deposited in one of the plurality of defined locations, and wherein the inner tray is disposed within a plastic freezer bag.

### BRIEF DESCRIPTION OF THE DRAWINGS

FIG. 1 provides a flow chart of an embodiment of the method of the present invention.

FIG. 2 provides an illustration of a perspective view of an embodiment of an apparatus for containing frozen clams.

FIG. 3 provides an illustration of a cut away view of an embodiment of an apparatus for containing frozen clams.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a method and apparatus for freezing, storing and cooking soft shell clams and jack knife clams.

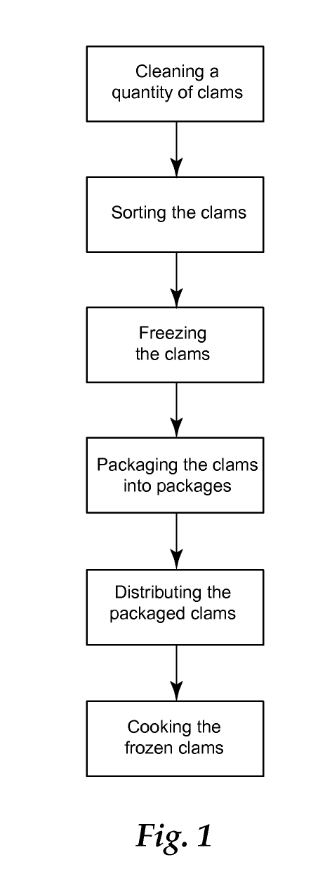

One aspect of the method of the present invention involves the steps of cleaning the clams, sorting the clams, freezing the clams, packaging the clams into packages, distributing the packaged clams, and cooking the frozen clams. One embodiment of this method is illustrated in FIG. 1.

The step of cleaning the clams may be performed in any manner sufficient to remove excess contaminants from the clam such as mud, algae, and other sediment. In one embodiment this step is carried out by hand by manually scrubbing and washing the clams in a washing solution such as salt water. In another embodiment, this step may be automated in a large water filled tank that has air pumped through its bottom to agitate the clams and to dislodge contaminants stuck to the clams.

The step of sorting the clams may be performed in any manner sufficient to remove broken clam shells and dead clams from a group of living clams. In one embodiment this may be done by hand, by manually inspecting the clams. In another embodiment, this sorting may be performed automatically by a multi-tier sorting apparatus that allows broken clam fragments to shift to a separate bottom portion, while live healthy clams are retained in a separate top portion.

The freezing step may be performed in a variety of manners that cause a clam internal temperature to be brought to a temperature below thirty two (32) degrees Fahrenheit. Preferably the freezing step involves bringing the clam internal temperature to below zero (0) degrees Fahrenheit. In one embodiment, the freezing step may be achieved by placing the clams in a vessel such as a freezer that has a temperature below zero degrees Fahrenheit. In another embodiment, a blast freezing process may be used to freeze the clams more rapidly than a conventional freezer by directing low-temperature air over the clams. In still another embodiment, a cryogenic fluid may be used to freeze the clams. Preferably, this freezing step occurs prior to packaging; however it may be performed after packaging without straying from the scope of the present invention. Once frozen, the clams preferably will remain frozen until they are cooked.

The step of freezing the clams is a vital step to the method of the present invention. The freezing process allows the freshness of the clams to be retained. In addition, the freezing process unexpectedly serves to increase the quality and eating experience of the clams. Preferably the freezing step is performed within 24 hours of the harvesting of the clams from their natural environment. This ensures that the clams are preserved at their peak freshness, and corresponding peak quality. The prior art teaches that most clams that are sold at a typical super-market are approximately 4-7 days old by the time they are sold. Therefore, this invention provides a substantial freshness advantage compared to conventional clam distribution. By freezing the clams, the present invention allows the clams to be eaten at their peak freshness for at least 6-8 months.

The step of freezing the clams is ideally performed while the clams are still alive. Alive being defined as living and uncooked. Freezing the clams while alive allows them to be cooked from a frozen and raw to fully cooked state, which maximizes quality of the clams.

In addition, the process of freezing the clams while alive produces the unexpected result of causing the clam body to be more easily removed from the dorsal hinge ligament that connects the clam to the shell. This easy removal increases the ease of eating the clams and makes their eating a more enjoyable experience.

Furthermore, the freezing of the clams while alive produces the unexpected result of drastically decreasing grit and sand particles in the clam, which enhances the eating experience. Therefore the process of freezing of the clams while still alive leads to a higher quality clam and a more enjoyable eating experience. The decrease of grit and sand particles is due at least in some part to the ease of removal of the dorsal hinge ligament, where a majority of the grit is located, and at least in some part because the grit and sand particles are expelled during the freezing process.

The step of packaging the clams may be carried out in any manner capable of containing and protecting the clams. Preferably the clams will be packaged in an FDA approved material such as a plastic freezer bag, a plastic tray within a plastic freezer bag, a sealed plastic tray within a cardboard box, or a sealed cardboard or foam tray. Preferably, the clams may be packaged in a tray designed to retain claims in a defined location. Further, the packaging may be microwave safe material.

The packaging may be of any size and shape capable of containing and protecting the clams. For example, the packaging may be sized to contain varying weights of clams, such as one, three, five, ten or fifty pound packages. The packaging may also be sized based on volume of clams, and may be sized to contain volumes such as a pint, half gallon, gallon, or five gallon packages.

In one embodiment, the packaging step may include the additional step of adding additional ingredients to the clam package. The flavorings may include any ingredients that may be desirable on a cooked clam. For example, clam broth, salt, pepper, butter, butter and garlic, citrus such as lemon, herbs such as sage, rosemary, oregano, or sauces such as white wine sauce, cream sauce, and the like.

The step of distributing the packaged clams preferably occurs after the clams are frozen and packaged. This distribution step may involve sending the clams to wholesalers and retailers who will directly sell the product to consumers, and may also include directly selling the clams to consumers. Distributing the clams once frozen and packaged allows the clams to be transported long distances, to stay fresh for long periods of time, and at the same time maintains superior quality of the clams. The distribution step may comprise distributing the clams to local markets, super-markets and wholesalers. The term “local” being defined as less than or equal to 100 miles of the freezing location. The distribution step may also comprise distributing the clams to locations distant from the freezing location, thereby vastly increasing the market for the clams. The term “distant” being defined as greater than 100 miles from the freezing location.

The step of cooking the clams may be carried out in a variety of manners. Preferably, the clams are cooked while frozen, however they may be defrosted and then cooked. This step may be performed while the clams remain in the package, or when they are unpackaged. Some examples of cooking methods may be cooking the clams in a microwave oven, a steam cooker, boiling water or broth, or the clams may be baked, grilled or broiled, among other methods.

In one embodiment, the clams may be packaged in a plastic bag designed to release steam at a given pressure within the bag. This packaging may allow the clams to steam easily and effectively in the bag that they are packaged in when cooked in a microwave oven.

In another embodiment, the clams may be packaged in a fully sealed bag or tray. In this embodiment, if the clams are to be cooked in a microwave, a small incision may be made in the bag or tray seal to allow release of excess steam created in the microwave cooking process. In this embodiment, if the clams are to be cooked in a steam cooker or boiling water, it is preferable that they remain sealed in the package to maintain as much broth from the clams as possible.

An advantage to the present method is that the concern of contamination of the clams is minimized by the freezing process and subsequent cooking process, whereby the low temperatures kill or at least inhibit growth of many infections agents, and the steam created in a proper and complete cooking process fully sterilizes the clams.

In another aspect the present invention contemplates an apparatus for freezing, storing and cooking clams, particularly soft shell clams, and jack knife clams. The apparatus may comprise a freezer for freezing the clams, a package for storing, protecting, and containing the claims during cooking and a heating device to heat and cook the clams.

The freezer may act to bring the internal temperature of the clams to below thirty two degrees Fahrenheit. Preferably the internal temperature of the claims is brought to below zero degrees Fahrenheit.

In one embodiment the freezer may be a device that has an internal temperature below thirty two degrees Fahrenheit. By placing a quantity of clams inside, and allowing the clam internal temperature to drop below thirty two degrees Fahrenheit, freezing of the clams is achieved.

In another embodiment, the freezer may be a blast freezer. The blast freezer may employ a cold gas flow to utilize convective chilling to freeze the clams.

In yet another embodiment, the freezer may employ cryogenic fluid such as liquid nitrogen to freeze the clams.

The package for storing, protecting and containing the claims during cooking may be of any size and shape capable of storing and protecting the clams, and also capable of allowing the clams to be cooked within it. For example, the package may be a sealable plastic bag, a sealable cardboard, foam or plastic tray, a plastic tray within a cardboard box, or a combination of these packages. The package may be filled with clams, and then sealed.

In one embodiment, the package may be self-venting such that when the clam and package are cooked in a microwave oven, the sealed package is able to release gasses created during the cooking process once the pressure inside the package reaches a pre-determined level.

In one embodiment, the clams may be vacuum packed inside the package, by applying a vacuum to the package before sealing. In another embodiment, the package may be filled with an inert gas such as nitrogen and then sealed, thereby providing an inert atmosphere for the clams when packaged.

The package may optionally contain additional ingredients such as flavoring, seasoning, or clam broth. The additional ingredients may enhance the quality, flavor and overall eating experience of the clams. In one embodiment, the additional ingredients may be in the form of frozen pellets, such that they melt and coat the clams during the cooking process. In another embodiment, the clams may be coated with the additional ingredients either before or after being frozen. In a further embodiment, the ingredients may be separately packaged.

In one embodiment, the package may have an outer plastic bag, an inner tray, and a plurality of frozen clams. The inner tray may have a plurality of defined locations, each capable of holding and securing a clam. One of the plurality of clams may be deposited in each defined location. The clams deposited on the inner tray may then be deposited and secured within the outer plastic bag, and may be shipped, and cooked as packaged. By having the clams fixed in a particular location, even cooking and heat circulation is encouraged, and the clams are less likely to damage each other in the shipping and distribution process.

In one embodiment the defined locations of the inner tray may be a series of protrusions that extend outwardly from a surface of the inner tray. The protrusions define a substantially oval clam shape, and act as walls to prevent the clam from moving laterally.

In another embodiment, the defined locations of the inner tray may be constructed as a substantially circular to oval clam shaped depression in the inner tray, allowing the clam to sit in the depression.

In yet another embodiment, the defined locations may be a combination of a substantially oval shaped depression, and a series of protrusions defining a substantially circular to oval shape around the depression.

In a further embodiment, the bag may be sized to fit relatively tightly over the clams, thereby preventing the clams from being dislodged from their defined locations. In one embodiment, this may be achieved by applying a vacuum to the package. In another embodiment, this may be achieved by limiting the size of the package so that it fits snuggly over the clams when deposited in the defined locations.

In this embodiment, preferably the plastic bag includes a self venting feature to allow the release of pressure from the inside of the package caused by the creation of steam in the cooking process. The self venting feature aids in cooking the clams by maintaining a specific pressure and temperature within the bag during microwave cooking.

Preferably, all materials used, including the packaging material, are food grade, Food and Drug Administration (FDA) approved materials.

The heating device may be any device capable of heating and cooking the clams, including a microwave oven, a steam cooker, boiling water or other heated liquid, an oven, range, or grill, for example.

In one embodiment, the heating device is a microwave. The approximate amount of time required in a standard microwave on high is eight minutes, although cooking times may vary depending on microwave power, amount of clams being cooked, and user preference.

In another embodiment, the heating device is a steam cooker. The approximate amount of time required in a steam cooker embodiment is sixteen minutes, although cooking times may vary depending on the effectiveness of the steam cooker, the size of the package, amount of clams being cooked, and user preferences.

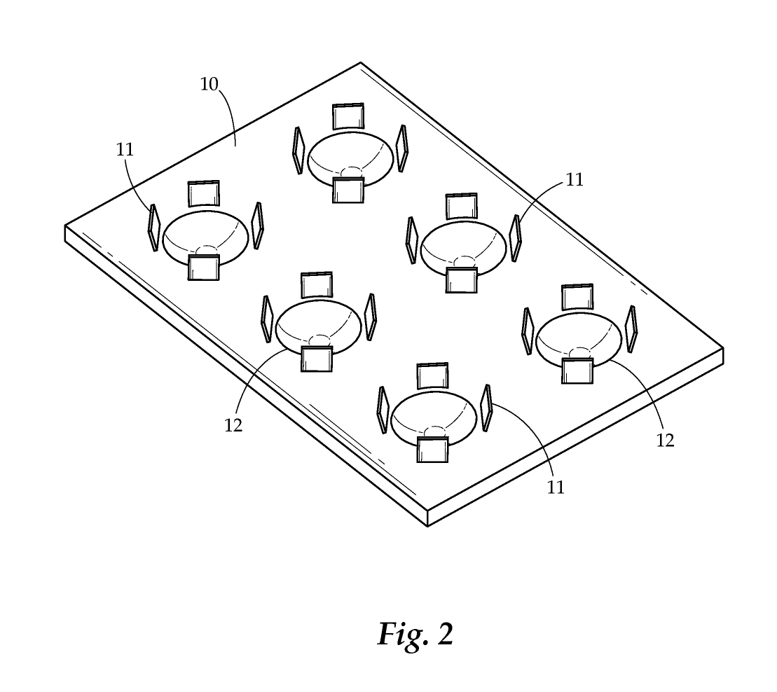

Turning now to FIG. 2, an embodiment of the apparatus of the present invention is shown. The apparatus includes a tray 10 having a plurality of tabs 11 extending from an upper surface of the tray 10. The tray 10 also has a depression 12 which is substantially circular in shape. The tabs 11 and the depression 12 form a defined location for the receipt of a clam 13. The tray 10 is shown to define a six of these defined locations each capable of receiving a clam 13, however the number of defined locations may vary without straying from the scope of the invention.

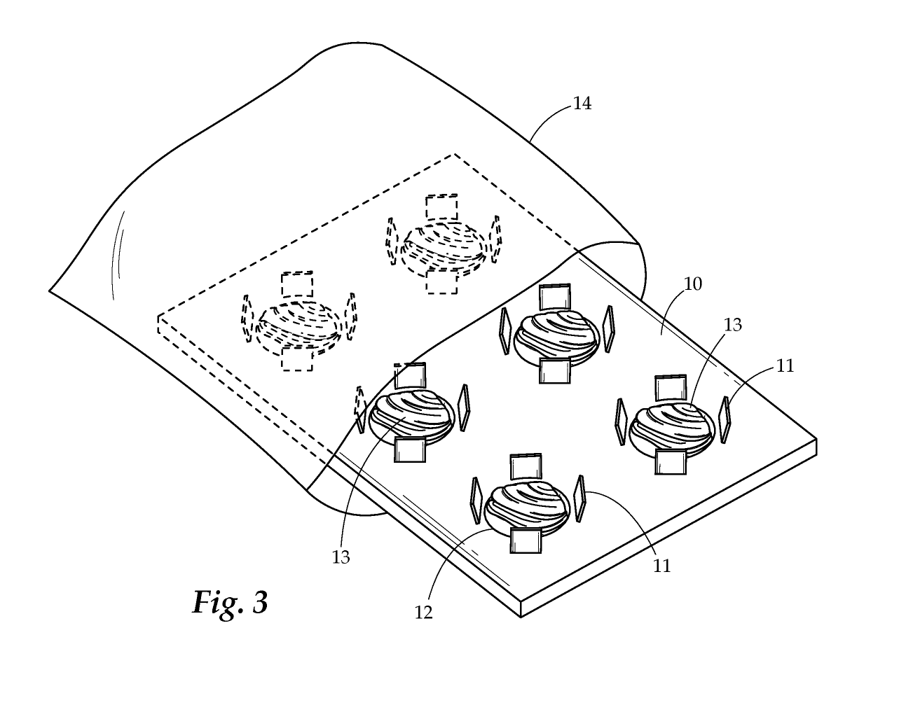

FIG. 3 shows a cutaway of an embodiment of the packaged apparatus. The tray 10 has a clam 13 deposited within each of its defined locations. Each clam 13 is secured within the depression 12 and limited in lateral movement by the tabs 11. The tray 10 is shown positioned partially within the plastic freezer bag 14. The plastic freezer bag 14 is constructed and arranged to store and protect the clam 13 and also to act as a container for cooking the claims 13.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A method of preserving clams comprising the steps of:
cleaning a clam;
sorting the clam;
freezing the clam while the clam is alive;
packaging the clam; and
cooking the clam.

2. The method of preserving clams of claim 1 wherein the clam is selected from the group consisting of soft shell clams and jack knife clams.

3. The method of preserving clams of claim 2 further comprising the step of distributing the clam.

4. The method of preserving clams of claim 3 wherein the step of distributing the clam further comprises the steps of:
distributing a first clam to a local market; and
distributing a second clam to a market distant from the point of harvest.

5. The method of preserving clams of claim 2 wherein the step of freezing the clam while the clam is alive further comprises lowering an internal temperature of the clam to below zero degrees Fahrenheit.

6. The method of preserving clams of claim 2 wherein the step of freezing the clam while the clam is alive is achieved by blast freezing.

7. The method of preserving clams of claim 5 wherein the step of cooking the clam further comprises:
placing an unopened package of frozen clam in a microwave oven;
activating the microwave oven; and
deactivating the microwave oven once the clam is fully cooked.

8. The method of preserving clams of claim 2 wherein the step of packaging the clam further comprises adding an additional ingredient to a clam package.

9. The method of preserving clams of claim 2 wherein the step of packaging further comprises:
placing a clam in a designated location of a tray;
placing the tray within a plastic freezer bag;
applying a vacuum to an interior of the plastic bag; and
sealing the plastic bag.

10. A method of preserving clams comprising the steps of:
cleaning a clam;
sorting the calm;
processing the clam to make a dorsal ligament of the clam easily removable from a body of the clam;
processing the clam to reduce a quantity of sand grit within the clam;
processing the clam to preserve a freshness of the clam;
packaging the clam; and
cooking the clam.

11. The method of preserving clams of claim 10 wherein the steps of processing the clam to make a dorsal ligament of the clam easily removable, processing the clam to reduce the quantity of sand grit within the clam, and processing the clam to preserve a freshness of the clam is performed by freezing the clam while alive.

12. The method of preserving clams of claim 11 wherein the clam is selected from the group consisting of soft shell clams and jack knife clams.

13. The method of preserving clams of claim 12 further comprising the step of distributing the clam.

14. The method of preserving clams of claim 12 wherein the step of packaging the clam further comprises adding an additional ingredient to a clam package.

15. The method of preserving clams of claim 12 wherein the step of packaging further comprises:
placing the clam in a designated location of a tray;
placing the tray within a plastic freezer bag;
applying a vacuum to an interior of the plastic bag; and
sealing the plastic bag.

16. An apparatus for containing frozen clams comprising:
a tray, having an upper surface, and a plurality of defined locations on the upper surface constructed and arranged to receive a clam;
the clam deposited in one of the plurality of defined locations; and
wherein the tray is disposed within a plastic freezer bag.

17. The apparatus for containing frozen clams of claim 16 wherein the clam is selected from the group consisting of soft shell clams and jack knife clams.

18. The apparatus for containing frozen clams of claim 17 further comprising a freezing device for freezing the clam.

19. The apparatus for containing frozen clams of claim 18 further comprising a heating device for heating and cooking the clam.

20. The apparatus for containing frozen clams of claim 19 wherein the clam is frozen while alive.
